(19) United States
(12) Patent Application Publication
(10) Pub. No.: US 2026/0203654 A1
(43) Pub. Date: Jul. 16, 2026

(54) FEDERATED LEARNING AND MANAGEMENT OF GLOBAL AI MODEL IN WIRELESS COMMUNICATION SYSTEM

(71) Applicant: SAMSUNG ELECTRONICS CO., LTD., Suwon-si, Gyeonggi-do (KR)

(72) Inventors: Sripada KADAMBAR, Bangalore (IN); Ashok Kumar Reddy CHAVVA, Bangalore (IN); Ashwini KUMAR, Bangalore (IN); Samar Ranjan BAL, Bangalore (IN); Shubham Kumar JHA, Bangalore (IN)

(21) Appl. No.: 19/128,953

(22) PCT Filed: Nov. 9, 2023
(86) PCT No.: PCT/KR2023/017947

§ 371 Date: May 9, 2025

(30) Foreign Application Priority Data
Nov. 11, 2022 (IN) 202241064588
Oct. 27, 2023 (IN) 202241064588

(51) Int. Cl. G06N 20/00; H04W 24/10

(52) U.S. Cl. CPC G06N 20/00; H04W 24/10

(57) ABSTRACT

The present disclosure is related to Artificial Intelligence learning system. More particularly the present disclosure is related to a federated learning and management of global AI model in a wireless communication system. In line with development of the communication systems, there is a need for a federated learning and management of global AI model in wireless communication system.

### TECHNICAL FIELD

The present disclosure is related to Artificial Intelligence learning system. More particularly the present disclosure is related to a federated learning and management of global AI model in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

As mobile devices continue to proliferate and wireless communications advance at a rapid pace, a significant volume of data is being transmitted via the wireless communication network. This wireless data is increasingly being analysed by machine learning and Artificial Intelligence (AI) models. By deploying such AI models over the wireless communication network, enhancements in Channel State Information (CSI) compression, as well as CSI prediction, can be attained.

In current methodologies, AI models operating on wireless communication system are trained utilizing generalized datasets stored within a centralized server.

Traditional AI models within a wireless communication system are trained via a centralized server linked to one or more UEs. The server collects local datasets from these UEs and trains the AI model accordingly. Unfortunately, this data collection process places an additional burden on the network. Thus, the storage of the local datasets requires large number of resources for AI model deployment and consumes large amount of memory space.

### DISCLOSURE OF INVENTION

### Technical Problem

In line with development of the communication systems, there is a need for a federated learning and management of global AI model in wireless communication system.

The principal object of the embodiments herein is to provide a federated learning and management of global AI model in wireless communication system.

Another object of the embodiments herein is to select an optimal participant UEs for federated learning in wireless communication system.

Another object of the embodiments herein to facilitate the seamless encoding and decoding of an AI model, thereby enabling its efficient sharing between the network and participant UEs. The network may encompass a base station and a parameter server, while the encoding and decoding process is carried out by utilizing an appropriate scheme that is tailored to suit the unique requirements of both the participant UEs and the network.

Another object of the embodiments herein is to perform signalling procedures for the federated learning of the AI model within the wireless communication system.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Accordingly, the embodiment herein is to provide a method, UE, a base station and a parameter server for performing the federated learning in the wireless communication system. Initially parameter server prepares AI model for local epoch and transmits to BS. Further BS receives partially trained AI model and determines set of participant UEs based on CSI report and capability information of plurality of UEs. Further BS transmits FLTC to set of participant UEs. Further BS determines encoding method to encode partially trained AI model. Thereafter BS transmits encoded partially trained AI model to set of participant UE. Furthermore, set of participant UE decodes received AI model and performs training using local dataset. Also, set of participant UEs transmits encoded locally trained AI model to BS. Upon receiving, BS decodes locally trained AI model and transmits to PS for generating global AI model.

Accordingly, the embodiment herein is to provide a method of federated learning in wireless communication system. The method includes receiving, by a Base Station (BS), a local training request to generate a global AI model through federated learning from a parameter server (PS). Further, the method includes receiving UE capability information and CSI report from a plurality of UEs in the wireless communication system. Thereafter the method includes determining a set of participant UEs from the plurality of UEs for local epoch training based on the capability information and the CSI report received from each of the UEs. Furthermore, the method includes determining a Federated Learning Training Configuration (FLTC) for at least one UE of the set of participant UEs based on the CSI received in the CSI report from each of the participant UEs. Also, transmitting a partially trained AI model for local epoch training and the FLTC to the set of participant UEs. The FLTC is different for each participant UE based on which the partially trained AI model needs to be locally trained by the set of participant UEs. Moreover, receiving locally trained AI models from the set of participant UEs, where the locally trained AI models are generated by locally training the partially trained AI model based on the FLTC and the CSI report received by the set of participant UEs. Further, the method includes transmitting the locally trained AI model received from the set of participant UE to the BS for generating the global AI model.

In an embodiment, the method includes determining the set of participant UEs from the plurality of UEs for local epoch training based on the UE capability information and the CSI report received from each of the UEs comprises determining whether channel condition indicated in the CSI report meets a predefined channel condition threshold. Further the method includes selecting the set of participant UEs from the plurality of UEs for local epoch training, wherein the channel condition of the selected set of participant UEs meets the predefined channel condition threshold and the UE capability information of the selected set of participant UEs indicates support for the local epoch training.

In an embodiment, the FLTC comprises at least one of layer update information of the at least one layer of the partially trained AI model, a local epoch training timer for the participant UE to locally train the partially trained AI model, a local epoch model upload timer for the participant UE to upload the locally trained AI model, a number of local epochs for the participant UE, time resource information for time resources allocated to the participant UE for the local epoch training, frequency resource information for frequency resources allocated to the participant UE for the local epoch training, a learning rate to locally train the partially trained AI model, a batch size for locally training the partially trained AI model, an optimizer to locally train the partially trained AI model, save optimizer state, model quantization type to locally train the partially trained AI model, local dataset size, and preprocessing configuration indicating a type of preprocessing and scaling parameters to locally train the partially trained AI model.

In an embodiment, the method includes transmitting the FLTC to at least one participant UE of the set of participant UEs comprises determining whether at least one participant UE of the set of participant UEs participates for the local epoch training meets a predefined participation threshold. Further, the method includes transmitting the FLTC to the at least one participant UE of the set of participant UEs in a RRC message when the at least one participant UE meets the predefined participation threshold. Furthermore, the method includes transmitting the FLTC to the at least one participant UE of the set of participant UEs in a DCI message when the at least one participant UE does not meets the predefined participation threshold.

In an embodiment, the RRC message or the DCI message comprises information about an encoding method used by the BS.

In an embodiment, the method includes receiving the locally trained AI model from at least one participant UE of the set of participant UEs comprises receiving a local epoch training completion message from at least one participant UE of the set of participant UEs. Further, the method includes transmitting a DCI message to at least one participant UE of the set of participant UEs to upload the locally trained AI model to the BS. Thereafter, the method includes receiving the locally trained AI model uploaded by at least one participant UE of the set participant UE.

In an embodiment, the method includes selecting, by the BS, a subset of participant UEs from the set of participant UEs that meets a predefined participation threshold.

In an embodiment, the method includes transmitting the partially trained AI model for the local epoch training comprises receiving, the partially trained AI model from the PS. Further, the method includes determining, Modulation Coding Scheme (MCS) and Rank Indicator (RI) based on the CSI report received from at least one participant UE of the set of participant UEs. Also, the method includes assigning time and frequency resources to at least one participant UE of the set of participant UEs. Furthermore, the method includes determining payload based on the MCS, RI, and the assigned time and frequency resources to at least one participant UE of the set of participant UEs. Thereafter, the method includes determining differential data for the partially trained AI model based on a previously shared AI model with at least one participant UE of the set of participant UEs. Further, the method includes encoding the differential data for the partially trained AI model. Finally transmitting the encoded partially trained AI model with the differential data to at least one participant UE of the set of participant UEs.

In an embodiment, the method includes receiving the partially trained AI model from the PS comprises receiving a request to share fairness score of the at least one participant UE of the set of participant UEs from the PS. Further the method includes sending the fairness score and information about the at least one participant UE to the PS. Furthermore, the method includes receiving the partially trained AI model generated by the PS based on the fairness score and information about the at least one participant UE.

In an embodiment, the method includes encoding the differential data for the partially trained AI model comprises determining an encoding method supported by the UE and the BS from a plurality of encoding methods based on at least one of bits per AI model parameter (BPMP) with RRC LUT and DCI based explicit signalling. Further the method includes encoding the differential data for the partially trained AI model using the encoding method supported by the UE and the BS.

Accordingly, the embodiment herein is to provide a method of federated learning in wireless communication system. The method includes transmitting, by the UE, UE capability information to a BS in the wireless communication system, wherein the UE capability information indicates support for the local epoch training. Further, the method includes transmitting a CSI report to the BS. Furthermore, the method includes receiving a partially trained AI model for the local epoch training and a FLTC specific to the UE from the BS for the local epoch training. Thereafter, decoding the partially trained AI model. Also, generating a locally trained AI model by locally training the partially trained AI model based on the FLTC and the CSI report. Finally, transmitting the locally trained AI model to the BS.

Accordingly, the embodiment herein is to provide a method of federated learning in wireless communication system. The method includes sending, by the parameter server, a local training request to a BS. Further the method includes receiving information about at least one participant UE for the local epoch training and fairness score associated with at least one participant UE. Also, the method includes generating a partially trained AI model for the at least one participant UE based on the information about at least one participant UE for the local epoch training and the fairness score. Furthermore, the method includes transmitting the partially trained AI model to the BS for local epoch training by at least one participant UE. Finally, the method includes receiving the locally trained AI model from the BS where the locally trained AI model is generated by locally training the partially trained AI model by the at least one participant UE.

Accordingly, the embodiment herein is to provide a Base Station (BS) for federated learning in wireless communication system. The Base station comprises a memory, a processor and a federated learning controller. The federated learning controller is communicatively coupled to the memory and the processor. The federated learning controller is configured to receive a local training request to generate a global AI model through federated learning from a parameter server (PS). Further, receives UE capability information and CSI report from a plurality of UEs in the wireless communication system. Furthermore, determine a set of participant UEs from the plurality of UEs for local epoch training based on the UE capability information and the CSI report received from each of the UEs. Thereafter, determine a Federated Learning Training Configuration (FLTC) for at least one participant UE of the set of participant UEs based on the CSI received in the CSI report received from each of the participant UEs. Also transmits a partially trained AI model for the local epoch training and the FLTC to the set of participant UEs, wherein the FLTC is different for each participant UE of the set of participant UEs based on which the partially trained AI model needs to be locally trained by the set of participant UEs. Finally, receives locally trained AI models from the set participant UE, wherein the locally trained AI models are generated by locally training the partially trained AI model based on the FLTC and the CSI report by the set of participant UEs. Finally transmits the locally trained AI models received from the set of participant UEs to the PS for generating the global AI model.

Accordingly, the embodiment herein is to provide a User Equipment (UE) for federated learning in wireless communication system. The UE comprises a memory, a processor and a federated learning controller. The federated learning controller is communicatively coupled to the memory and the processor. The federated learning controller of the UE is configured to initially transmit UE capability information to a BS in the wireless communication system, where the UE capability information indicates support for local epoch training. Further, transmits a CSI report to the BS. Also, receives a partially trained AI model for the local epoch training and a FLTC specific to the UE from the BS for the local epoch training. Furthermore, decode the partially trained AI model. Thereafter, generates a locally trained AI model by locally training the partially trained AI model based on the FLTC and the CSI report. Finally, transmits the locally trained AI model to the BS.

Accordingly, the embodiment herein is to provide a parameter server (PS) for federated learning in wireless communication system. The PS comprises a memory, a processor and a federated learning controller. The federated learning controller of the PS is configured to initially send a local training request to a BS. Further, receives information about at least one participant UE for the local epoch training and a fairness score associated with the at least one participant UE. Also, generates a partially trained AI model for the at least one participant UE based on the information about at least one participant UE for the local epoch training and the fairness score. Furthermore, transmits the partially trained AI model to the BS for local epoch training by the at least one participant UE. Thereafter, receives locally trained AI model from the BS where the locally trained AI model is generated by locally training the partially trained AI model by at least one participant UE. Finally generates a global AI model by aggregating the locally trained AI models received from the BS.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein.

### Advantageous Effects of Invention

The present disclosure provides an effective and efficient method for a federated learning and management of global AI model in wireless communication system. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1A illustrates a block diagram of a generic model deployment;

FIG. 1B illustrates a block diagram of a customized AI model deployment;

FIG. 2A illustrates a high-level overview of the wireless communication system interaction between the federated learning entities for performing federated learning to generate a global AI model in a wireless communication system, according to the embodiments as disclosed herein;

FIG. 2B illustrates a block diagram of a federated learning lifecycle in a wireless communication system, according to the embodiments as disclosed herein;

FIG. 3A illustrates a block diagram of a base station for federated learning in a wireless communication system, according to the embodiments as disclosed herein;

FIG. 3B illustrates a block diagram of a User Equipment for federated learning in a wireless communication system, according to the embodiments as disclosed herein;

FIG. 3C illustrates a block diagram of a parameter server for federated learning in a wireless communication system, according to the embodiments as disclosed herein;

FIG. 4A depicts a sequence diagram that illustrates sharing of FLTC in RRC message between the UE and BS, according to the embodiments as disclosed herein;

FIG. 4B depicts a sequence diagram that illustrates sharing FLTC in a DCI message between the UE and BS, according to embodiments as disclosed herein;

FIG. 5 depicts a sequence diagram that illustrates multi-level FLTC signalling using both RRC message and DCI message, according to the embodiments as disclosed herein;

FIG. 6 illustrates signalling flow for a local epoch training by the BS to execute a federated learning in the wireless communication system, according to the embodiments as disclosed herein;

FIG. 7 is a flow diagram illustrating a method for sharing AI model by the BS with the UE for global epoch participation, according to the embodiments as disclosed herein;

FIG. 8A is a flow diagram illustrating a method for signalling Encoding Method by the BS using RRC message to the UE for federated learning in the wireless communication system, according to the embodiments as disclosed herein;

FIG. 8B depicts a sequence diagram that illustrates a signalling of Encoding Method by the BS using RRC message to the UE for federated learning in the wireless communication system, according to the embodiments as disclosed herein;

FIG. 8C depicts a sequence diagram that illustrates signalling of Encoding Method by the BS using DCI message to the UE for federated learning in the wireless communication system, according to the embodiments as disclosed herein;

FIG. 9 depicts a flow diagram that illustrates a method of partially trained AI model reception decoding by the UE for federated learning in wireless communication system, according to the embodiments as disclosed herein;

FIG. 10 depicts a sequence diagram that illustrates global training at the UE using a local dataset at the UE, according to the embodiments as disclosed herein;

FIG. 11 depicts a sequence diagram that illustrates interaction between the UE and the BS for updating and uploading locally trained AI model by the UE, according to the embodiments as disclosed herein;

FIG. 12 depicts a sequence diagram that illustrates signalling between the Base station, parameter server and the UE for federated learning in wireless communication system, according to the embodiments as disclosed herein; and

FIG. 13 depicts a sequence diagram that illustrates the federated learning timers to perform federated learning in the wireless communication system, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

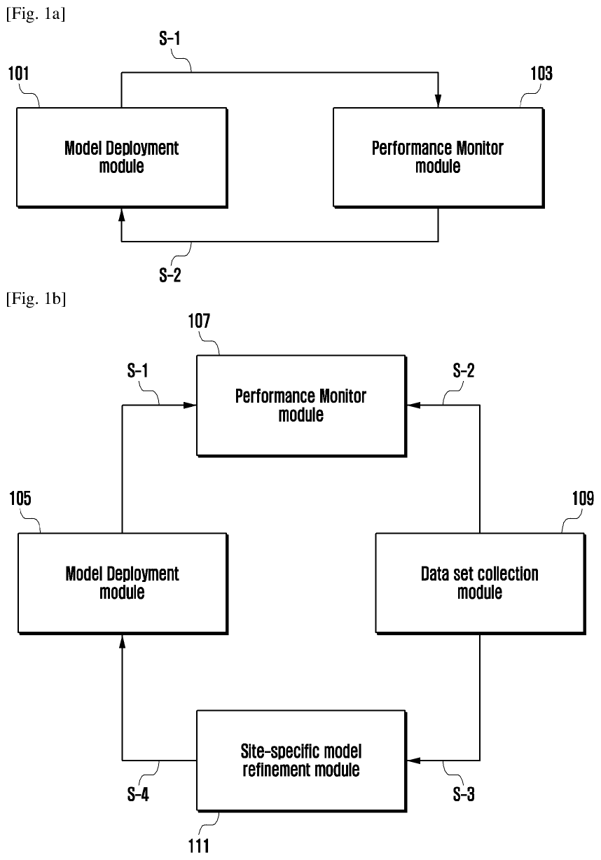

FIG. 1A illustrates a block diagram of a generic model deployment. This model includes an AI or non-AI model and is initially deployed within a wireless communication system by a model deployment module (101). The generic model is subsequently trained through a shared dataset, which may be either a stored or predefined dataset for the deployed AI model. Following training at step S1, the trained AI model is transmitted to a performance monitor module (103) that monitors the model's efficacy. Such efficiency is measured through several model parameters such as accuracy, complexity and performance. Lastly, step S2 entails the further updating of the trained AI model using the shared dataset. This deployment of the generic model represents an ideal foundation during the AI model's early stage, yet it yields a lower performance. Consequently, there exists a requirement for an enhanced methodology for training the AI model within the wireless communication system.

FIG. 1B illustrates a block diagram of a customized AI model deployment. Alternatively, it depicts a traditional technique of training the AI model implemented in the wireless communication system. Specifically, the FIG. 1B displays a customized AI model deployment or a site-specific AI model deployment. In the initial stage, the model deployment module (105) can deploy the AI model either at the network side or the UE side. Next, the AI model is transmitted to a Performance Monitor module (107) at step S1, which monitors the performance of the deployed AI model. Based on the performance executed by the deployed AI model, a data set collection module (109) collects additional datasets from the one or more UEs associated with the base station or the UE at which the AI model is deployed at step S2. Subsequently, the collected additional dataset is transmitted to a site-specific model refinement module (111) at step S3. The site-specific model refinement module refines the deployed AI model using the collected additional dataset. Finally, at step S4, the refined AI model is deployed and continues with the training of the refined AI model. Therefore, in the customized AI model deployment, the AI model is trained with a more extensive dataset received from one or more UEs, resulting in superior performance. Additionally, the customized AI model deployment yields better performance when compared to that of the generic model deployment. However, the additional dataset collected from the one or more UEs needs to be stored in a centralized location, and the large dataset collection from one or more UEs creates an overhead on the uplink. Consequently, there is a need for an improved method and system for deploying the AI model in the wireless communication system.

The proposed method performs a federated learning of the deployed AI model within the wireless communication system. The federated learning is performed in a distributed fashion across numerous UEs in the wireless communication system. Within the proposed invention, the UEs selected as one or more participant(s) for the federated learning of the partially trained AI model are chosen based on their inherent capabilities and channel conditions. In the proposed method, the partially trained AI model is locally trained at the participant UEs through the use of their respective local datasets. Subsequently, the participant UEs transmit their locally trained AI models to a parameter server via a base station, after which the parameter server integrates the locally trained AI models into an updated and refined global AI model. This approach is advantageous as the global AI model are locally trained at the UEs, thereby reducing the overhead at the uplink. Furthermore, the performance of the global AI models is significantly enhanced through this methodology.

In the present disclosure, an AI model that is deployed by the parameter server before the initiation of the global epoch for performing the federated learning across the plurality of UEs is referred to as a deployed AI model. Also, the parameter server can transmit partially trained AI model to the BS upon the completion of the first global epoch. The partially trained AI model is referred to as AI model which is updated in i−1^{th} global epoch.

Further, at least one of the deployed AI model or partially trained AI model is received by the base station. The BS transmits the partially trained AI model to the UEs for further training.

The UEs receives the deployed AI model or partially trained AI model and generates a locally trained AI model. The locally trained AI model is the AI model that is locally trained by the UEs using the local dataset associated with the UEs.

Upon local training, the parameter server generates the global AI model. The global AI model is the AI model that is generated by combining the locally trained AI model received from the UEs. The global AI model can also be referred to as an updated AI model or a refined AI model.

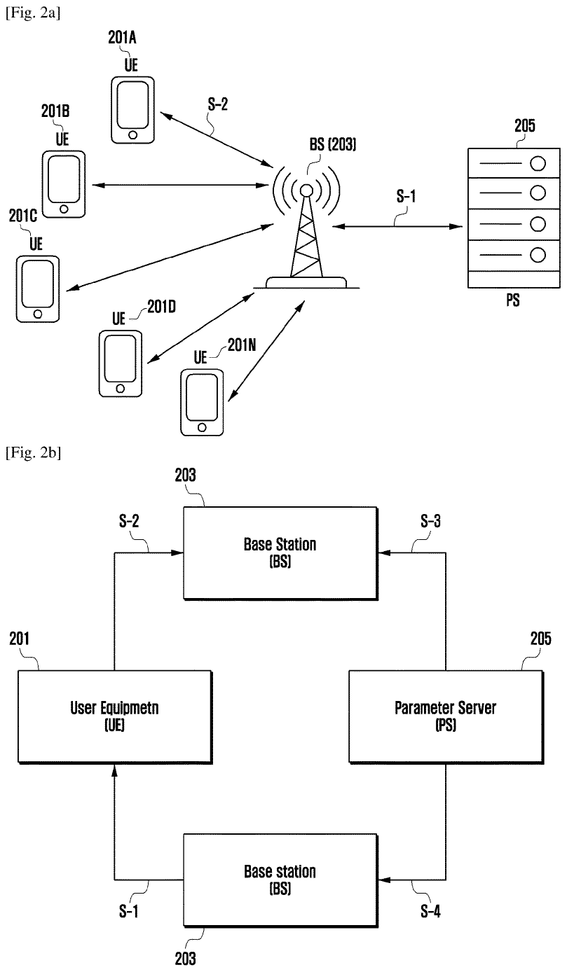

FIG. 2A illustrates a high-level overview of the wireless communication system interaction between the federated learning entities for performing federated learning to generate a global AI model in a wireless communication system, according to the embodiments as disclosed herein. FIG. 2A illustrates an interaction between entities involved in the federated learning of the AI model in the wireless communication system. The entities in a wireless communication system involved in the federated learning of the AI model includes one or more of User Equipment's (UEs) (201₁₋ₙ) (herein after plurality of UEs is referred as 201), a Base Station (203) and a parameter server (205). The UEs (201₁₋ₙ) are electronic device having at least transmit and receive hardware, a memory, a processor, an antenna, a user interface and a power source. For example, the UE (201) can be, but not limited to a telephonic device, a smart phone, a tablet and a laptop. Further, the Base station (203) is a device that operates within a standards compliant network. Also, the base station (203) is a fixed transceiver which is a main communication point for of UEs (201₁₋ₙ). Further, in an embodiment, the parameter server (205) is a central server that stores model parameters to scale up partially trained AI model training performed on plurality of UEs (201). Thus, the federated learning of the deployed AI model is performed based on the interaction between the UE (201), the Base station (203) and the parameter server (205).

In Step S1, the parameter server (205) collaborates with the BS (203) to facilitate federated learning to generate the global AI model. The PS (205) signals the commencement of federated learning to the BS (203).

Next, in Step S2, the BS (203) initiates the collection of Channel State Information (CSI) reports from the plethora of UEs (201₁₋ₙ) through a CSI collection procedure. Based on the CSI reports and the capability information received from the UEs (201₁₋ₙ), the BS (203) selects a group of participant UEs with the most favourable channel conditions to partake in the federated learning. The partially trained AI model is encoded by the BS (203) before transmission to the selected participant UEs.

Additionally, the BS (203) transmits the partially encoded AI model and the Federated Learning Training Configuration (FLTC) to the selected set of UEs (201). The set of participant UEs (201) trains the partially trained AI model using their local datasets based on the information contained in the FLTC. The FLTC comprises of various details concerning the partially trained AI model training such as layer update information, local epoch training timers, local epoch model upload timers, local epoch numbers, time resource information, frequency resource information, learning rates, batch sizes, optimizers, model quantization types, local dataset sizes, and preprocessing configurations.

Upon completion of training, the set of participant UEs (201) informs the BS (203) of the same and are allocated resources for uploading the locally trained AI model. The BS (203) collects the locally trained AI models from the set of participant UEs (201) before transmitting them to the PS (205). Finally, the PS (205) aggregates the locally trained AI models to generate an updated and refined global AI model from the initially deployed AI model or partially trained AI model in Step S1.

The utilization of Federated Learning in the wireless communication system results in a highly refined global AI model. The partially trained AI model undergoes refinement through the use of local or site-specific datasets at the UEs participating in the process (201). This method reduces uplink overhead since there is no need to collect local datasets at a centralized location for model training. Instead, the partially trained AI model is transmitted to the participating UEs (201) for training using their respective local datasets. The final outcome is a combination of locally trained AI models at the participating UEs, resulting in an updated and refined AI model. This refined model guarantees enhanced performance, as it is trained using different local datasets at the participating UEs (201). The privacy of users is also maintained since their local datasets are not shared over the wireless communication system and the partially trained AI model is transmitted for Federated Learning at the participating UEs (201).

FIG. 2B illustrates a block diagram of a federated learning lifecycle in a wireless communication system, according to the embodiments as disclosed herein. FIG. 2B illustrates a federated learning lifecycle to generate global AI model. The federated learning lifecycle to generate global AI model illustrates the interactions between the plurality of UEs (201), the Base station (203) and the parameter server (205). Initially at step S1 consider the base station (203) shares a partially trained AI model to the set of participant UEs (201) for local update of the partially trained AI model. The BS (203) determines the set of participant UEs (201) based on the channel conditions of plurality of UEs (201) and capability information of the plurality of UEs (201). The channel conditions of plurality of UEs (201) is determined based on the CSI report received from plurality of UEs (201).

Further, the set of participant UEs (201) receives the partially trained AI model that needs to be trained. The set of participant UEs (201) trains the partially trained AI model using the local dataset. The local dataset is a collection of information stored at the set of participant UEs (201). Upon training, the set of participant UEs (201) encodes the locally trained AI model. Further at step S2, and transmits the locally trained AI model to the BS (203).

Further, the BS (203) receives the locally trained AI model from the set of participant UEs (201). Furthermore, at step S3, the BS (203) transmits the locally trained AI model to the parameter server (205). The parameter server (205) aggregates the received locally trained AI model and generates an updated global AI model. Upon, generating, the parameter server (205) validates the performance of updated global AI model. However, if the performance of the updated global AI model does not meet a predefined requirement then at step S4 the parameter server (205) transmits the updated global AI model to the BS (203) for further refinement. Thus, the cycle continues, until the updated global AI model meets a predefined requirement. The predefined requirement can include but not limited to include predefined accuracy of the AI model, and predefined performance of the AI model.

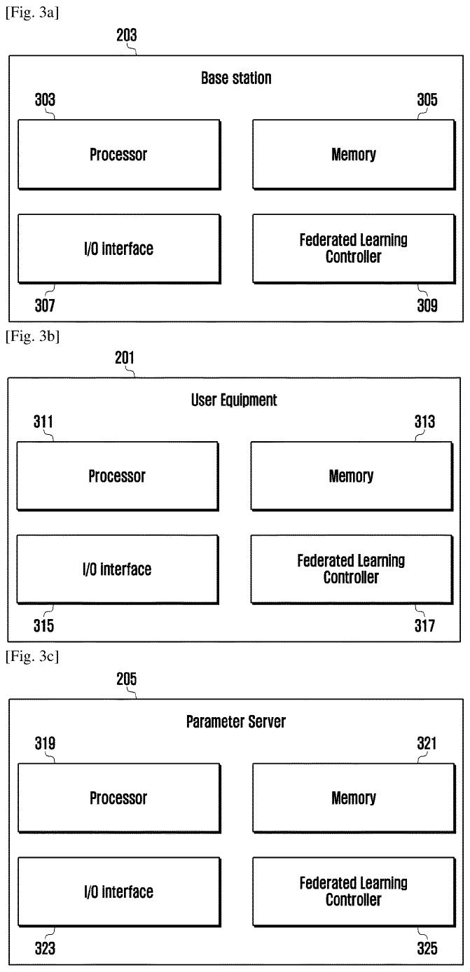

FIG. 3A illustrates a block diagram of a base station for federated learning in a wireless communication system, according to the embodiments as disclosed herein. The base station (203) includes a processor (303), a memory (305), an Input/Output (I/O) interface (307), and a federated learning controller (309). The base station (203) is a node in a wireless communication system that provides connectivity between User equipment (201) and parameter server (205). Also, the base station (203) is a fixed transceiver which is a main communication point for plurality of UEs (201). Further, the processor (303) of the base station (203) communicates with the memory (305), the I/O interface (307) and the federated learning controller (309). The processor (303) is configured to execute instructions stored in the memory (305) and to perform various processes. The processor (303) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (305) of the base station (203) includes storage locations to be addressable through the processor (303). The memory (305) is not limited to a volatile memory and/or a non-volatile memory. Further, the memory (305) can include one or more computer-readable storage media. The memory (305) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (305) can store the media streams such as audios stream, video streams, haptic feedbacks and the like.

The I/O interface (307) transmits the information between the memory (305) and external peripheral devices. The peripheral devices are the input-output devices associated with the base station (203). The I/O interface (307) receives several information from plurality of UEs (201), and the parameter server (205). The several information received from plurality of UEs can include but not limited to the channel conditions and capability information of the plurality of UEs (201). Also, the I/O interface (307) of the base station (203) receives partially trained AI model from parameter server (205) to initiate the federated learning, and Modulation coding schemes that can be used by the base station and plurality of UEs for the encoding and decoding of the partially trained AI model.

The federated learning controller (309) of the base station (203) communicates with the processor (303), I/O interface (307) and the memory (305) for performing the federated learning to generate the global AI model in the wireless communication system. Initially, the federated learning controller (309) receives a local training request to generate a global AI model through federated learning from the parameter server (205). Further, the federated learning controller (309) receives UE capability information from a plurality of UEs (201) in the wireless communication system. The UE capability information is indicated in the Radio Resource Configuration (RRC) message transmitted from the plurality of UEs (201) to the base station (203). Also, the federated learning controller (309) receives a CSI report from a plurality of UEs (201) in the wireless communication system. Furthermore, the federated learning controller (309) determines a set of participant UEs from the plurality of UEs (201) for local epoch training based on the UE capability information and the CSI report received from the plurality of UEs (201). Particularly the federated learning controller (309) selects the set of participant UEs from plurality of UEs (201) which is having the best channel conditions. Further, the federated learning controller (309) determines a Federated Learning Training Configuration (FLTC) for at least one participant UE of the set of participant UEs based on the CSI report. Also, the federated learning controller (309) transmits a partially trained AI model for local epoch training and the FLTC to set of participant UEs (201). The FLTC determined by the federated learning controller (309) is different for each participant UE of the set of participant UE (201). The FLTC comprises one or more information regarding the training of the partially trained AI model that is to be performed by the UE. For example, the FLTC comprises information including the number of layers that needs to be updated, local epoch training timer for the participant UE to locally train the partially trained AI model, local epoch model upload timer for participant UE to upload the locally trained AI model, number of local epochs for the participant UE, time resource information for time resources allocated to the participant UE to the participant UE for the local epoch training, frequency resource information for frequency resources allocated to the participant UE for the local epoch training, a learning rate to locally train the partially trained AI model, a batch size for locally training the partially trained AI model, an optimizer to locally train the partially trained AI model, save optimizer state, model quantization type to locally train the partially trained AI model, local dataset size, and preprocessing configuration indicating a type of preprocessing and scaling parameters to locally train the partially trained AI model. Upon transmitting, the federated learning controller (309) receives locally trained AI models from the set of participant UE. The locally trained AI model is generated by locally training the partially trained AI model based on the FLTC and the CSI report of the set of participant UE. Finally, the federated learning controller (309) transmits the locally trained AI model received from the set of participant UEs to the parameter server (205) for generating an updated global AI model.

FIG. 3B illustrates a block diagram of a User Equipment for federated learning in a wireless communication system, according to the embodiments as disclosed herein. The UE (201) includes a processor (311), a memory (313), an Input/Output (I/O) interface (315), and a federated learning controller (317). The UEs (201) is an electronic device having at least transmit and receive hardware, a memory, a processor, an antenna, a user interface and a power source. For example, the UE (201) can include but not limited to a telephonic device, a smart phone, a tablet and a laptop. Further, the processor (311) of the UE (201) communicates with the memory (313), the I/O interface (315) and the federated learning controller (317). The processor (311) is configured to execute instructions stored in the memory (313) and to perform various processes. The processor (311) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (313) of the UE (201) includes storage locations to be addressable through the processor (311). The memory (313) is not limited to a volatile memory and/or a non-volatile memory. Further, the memory (313) can include one or more computer-readable storage media. The memory (313) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (313) can store the media streams such as audios stream, video streams, haptic feedbacks and the like.

The I/O interface (315) transmits the information between the memory (313) and external peripheral devices. The peripheral devices are the input-output devices associated with the UE (201). The I/O interface (315) receives several information from base station (203), and the parameter server (205). The I/O interface (315) of the UE (201) receives the partially trained AI model, encoding method to encode the partially trained AI model, and FLTC for training the partially trained AI model locally.

The federated learning controller (317) of the UE (201) collaborates with its processor's I/O interface (315) and memory (313) to facilitate the federated learning to generate the global AI model within the wireless communication system. To begin, the UE's federated learning controller (309) transmits capability information to the BS (203) within the wireless communication system, typically through an RRC message during initial configuration. This capability information specifies the UE's support for local epoch training. The UE (201) then proceeds to transmit a CSI report to the BS (203). Following this, the UE (201) receives a partially trained AI model and a FLTC specific to the UE for local epoch training from the BS. The FLTC is typically received through one of the Radio Resource Configuration or Downlink Control Information messages. The UE (201) decodes the partially trained model and generates a locally trained AI model through its own local epoch training process, which is informed by the FLTC and CSI report. Ultimately, the UE (201) transmits the locally trained AI model to the BS (203).

FIG. 3C illustrates a block diagram illustrating of a parameter server for federated learning in a wireless communication system, according to the embodiments as disclosed herein. The parameter server (205) includes a processor (319), a memory (321), an Input/Output (I/O) interface (323), and a federated learning controller (325). The Parameter server (205) is a central server that stores model parameters to scale up partially trained AI model training performed on plurality of UEs (201). Further, the processor (319) of the parameter server (205) communicates with the memory (321), the I/O interface (323) and the federated learning controller (325). The processor (319) is configured to execute instructions stored in the memory (321) and to perform various processes. The processor (319) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (321) of the parameter server (205) includes storage locations to be addressable through the processor (319). The memory (321) is not limited to a volatile memory and/or a non-volatile memory. Further, the memory (321) can include one or more computer-readable storage media. The memory (321) can include nonvolatile storage elements. For example, non-volatile storage elements can include magnetic hard discs, optical discs, floppy discs, flash memories, or forms of electrically programmable memories (EPROM) or electrically erasable and programmable (EEPROM) memories. The memory (321) can store the media streams such as audios stream, video streams, haptic feedbacks and the like.

The I/O interface (323) transmits the information between the memory (321) and external peripheral devices. The peripheral devices are the input-output devices associated with the parameter server (205). The I/O interface (315) receives several information from base station (203), and the UE (201). The I/O interface (323) of the parameter server (205) transmits the encoded partially trained AI model for performing the federated learning to the BS and also receives the locally trained AI model from plurality of UEs (201).

The federated learning controller (325) interfaces with the processor (319) I/O (323) and memory (321) to facilitate the wireless communication system's AI model's federated learning. The federated learning controller (325) initially sends a local training request to the BS (203) and receives information on at least one participant UE, along with their associated fairness score, for local epoch training. Based on this information, the parameter server (205) generates a partially trained AI model for the participant UEs (201) and transmits the partially trained AI model to the BS for local epoch training. After the local training, the parameter server (205) receives locally trained AI models from the BS and aggregates them to generate a global AI model. Finally, the parameter server (201) transmits the updated global AI model to the BS.

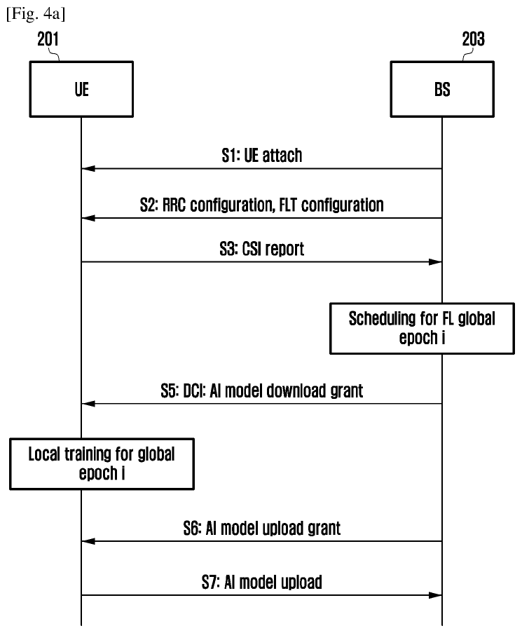

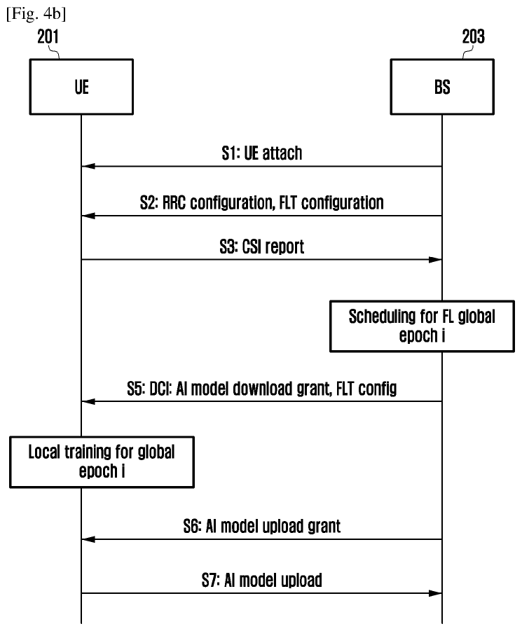

FIG. 4A depicts a sequence diagram that illustrates sharing of FLTC in RRC message between the UE and BS, according to the embodiments as disclosed herein. FIG. 4 illustrates the sequence diagram for sharing the FLTC between the UE (201) and the BS (203). The FLTC is shared by the BS to the UE in at least one of an RRC message and the DCI message to the plurality of UEs (201). The BS (203) transmits the FLTC to the UE based on a predefined participation threshold and the number of participant UEs (201). The BS (203) transmits the FLTC to the UE (201) in the RRC message when the UE (201) is expected to participate consistently in each local epoch of federated learning. In an embodiment, the BS (203) transmits the FLTC in the DCI message when the participation of the UE (201) is occasional. Also, the BS (203) transmits the FLTC in the DCI message when there large number of UE are participating in the federated learning. For example, when the number of UEs is greater than 1000 then the FLTC is transmitted in the DCI message. Initially at step S1, the BS (203) transmits an UE attach message to establish a connection with the plurality of UEs (201). Further at step S2, the BS (203) assigns and establishes radio resources with the plurality of UE (201) by transmitting an RRC. Also, at step S2 when the UEs (201) is determined to be consistent in each local epoch, then the base station (203) transmits the FLTC along with the RRC message. Upon receiving the RRC message, at step S3 the UE (201) transmits the Channel State Information (CSI) report to the BS (203). Thereafter, the BS (203) determines whether the UE (201) is capable for participating in the federated learning based on the capability information and CSI report received. Upon determining to be capable of participating the federated learning, at step S4 the BS (203) transmits a DCI message to the UE (201). The DCI message includes a partially trained AI model download grant indicating the UE (201) to download the partially trained AI model and to perform the local training on the partially trained AI model based on the FLTC. Further, the UE (201) downloads the received partially trained AI model and further trains the partially trained AI model using the local dataset stored at the UE (201). Upon training, the UE (201) indicates the completion of the training to the BS (203). Further, at step S5 the BS (203) transmits a grant message to the UE for uploading the locally trained AI model. Finally, at step S6 the UE (201) transmits the locally trained AI model to the BS (203). Similarly, a set of participant UEs transmits the locally trained AI model to the BS (203).

In an embodiment, the BS (203) transmits the FLTC using a DCI message. Also, the FLTC can be transmitted sing a semi-static activation through MAC control element (MAC-CE).

FIG. 4B depicts a sequence diagram that illustrates sharing FLTC in a DCI message between the UE and BS, according to embodiments as disclosed herein. In an embodiment, as shown in the FIG. 4B, at step S1 initially the BS (203) establishes a connection with the UE (201). During the connection establishment, the UE (201) shares the capability information with the BS (203). The capability information indicates capability of the UE (201) to support for local epoch training. Further, at step S2 the base station (203) assigns and establishes radio resources with the plurality of UE (201) by transmitting an RRC. Also, at step S2 when the Ues (201) is determined to be consistent in each local epoch, then the base station (203) transmits the FLTC along with the RRC message. Upon receiving the RRC message, at step S3 the UE (201) transmits the Channel State Information (CSI) report to the BS (203). Thereafter, the BS (203) determines whether the UE (201) is capable for participating in the federated learning based on the capability information and CSI report received. Upon determining to be capable of participating the federated learning, at step S4 the BS (203) transmits a DCI message to the UE (201). The DCI message includes an partially trained AI model download grant indicating the UE (201) to download the partially trained AI model and FLT configuration. The partially trained AI model download grant indicates the UE (201) to perform the local training on the partially trained AI model based on the FLTC. Further, the UE (201) downloads the received partially trained AI model and further trains the partially trained AI model using the local dataset stored at the UE (201). Upon training, the UE (201) indicates the completion of the training to the BS (203). Further, at step S5 the BS (203) transmits a grant message to the UE for uploading the locally trained AI model. Finally, at step S6 the UE (201) transmits the locally trained AI model to the BS (203). Similarly, a set of participant UEs transmits the locally trained AI model to the BS (203).

The FLTC transmitted to the UE (201) comprises one or more training parameters as shown below:

struct flt_config
{layer_update_info
local_epoch_training_timer
local_epoch_model_upload_timer
local_epochs
time_resource_info
freq_resource_info
learning_rate
batch_size
optimizer
save_optimizer_state
model_quantization_type
local_dataset_size
preprocessing_type
}

Particularly, layer_update_info indicates layers of the partially trained AI model to be trained as a part of local epoch training. For example, the layers for which the update is required is indicated as a bit value marked as weight update, and layers for which the update is not required is indicated as a bit value marked as skip updates. Similarly, the layer_update_info can be represented as log 2(L_{c}), where L_{c} denotes the number of layer combinations to be indicated during training. The layer update information can be represented in a tabular form as shown below in Table 1, where the bit 1 indicates that the corresponding layer has to be updated and the bit 0 indicates no update for the corresponding layer.

TABLE 1
FL layer update info

| | | | | | | |
|---|---|---|---|---|---|---|
| Bit position | 1 | 2 | 3 | . . . | L-1 | L |
| Value | 1 | 1 | 0 | . . . | 0 | 1 |

The local_epoch_training_timer indicates the duration by which the UE (201) should complete the local epoch training. The BS (203) will share the request for model upload, only after this interval.

The local_epoch_model_upload_timer indicates the duration by which the UE (201) should upload the locally trained AI model for the local epoch. Failure to upload the model within this interval is counted as local epoch participation failure by the UE (201).

The local_epochs indicate the number of local epochs for which the training should be performed at the UE using the local dataset.

The time_resource info and freq_resource_info indicates time and frequency resources over which the locally trained AI model download and upload is performed.

The learning_rate indicates the initial learning rate to be used during the local training at the UE. While training, this parameter may also be governed based on the optimizer method used at the time of training.

The batch_size indicates the local dataset batch size to be used by a UE (201) during training.

The optimizer indicates the optimizer to be used by the UE (201) during local training. For example, the optimizer includes ADAM optimizer, NADAM optimizer, Stochastic Gradient Descent (SGD).

The save_optimizer_state indicates the save state of the optimizer.

The model_quantization_type indicates the type of encoding and decoding scheme to be used to convert the model parameters to binary data and vice-versa. The model_quantization_type is chosen depending on the number of bits assigned per parameter during partially trained AI model sharing. For example, model quantization type includes a single-bit uniform quantization, B-bit uniform quantization and the like.

The local_dataset_size indicates the size of the local dataset that can be used during the local epoch training.

The preprocessing_type indicates type of pre-processing and the scaling parameters corresponding to the pre-processing that should be applied on the local dataset during training. The pre-processing includes application of scaling methods such as:

$$min - max : x = \frac{( x - {x}_{min} )}{{x}_{max} - {x}_{min}} and$$

$$Normalization : x = \frac{x - {x}_{m e a n}}{{x}_{max} - {x}_{min}}$$

Further, the FLTC parameters can be transmitted in both RRC message and the DCI message. Also, the FLTC parameters can be jointly deployed between RRC message and the DCI message to trade-off between signalling overhead and responsivity. For example, the FLTC parameters that are expected to change less frequently can be signalled using the RRC message. The one or more FLTC parameters that are expected to change less frequently includes as below:

struct fl_config_rrc
{
local_epochs
learning_rate
batch_size
optimizer
method_quantization_type
local_dataset_size
preprocessing_cfg
}

Similarly, the FLTC parameters that are expected to change more frequently can be signalled using the DCI message. For example, parameters related to model download, model upload and training configurations can be included in the DCI message. For example, consider the FLTC parameters that are included in the DCI message is as shown below in struct_fl_model_download_cfg, struct_fl_model_upload_cfg and struct_fl_training_cfg_dci:

struct fl_model_download_cfg
{time_resource_info
freq_resource_info
mcs
rank
struct fl_model_upload_cfg
{time_resource_info
freq_resource_info
mcs
rank
struct fl_training_cfg_dci
{layer_update_info
local_epoch_training_timer
local_epoch_model_upload_timer
}

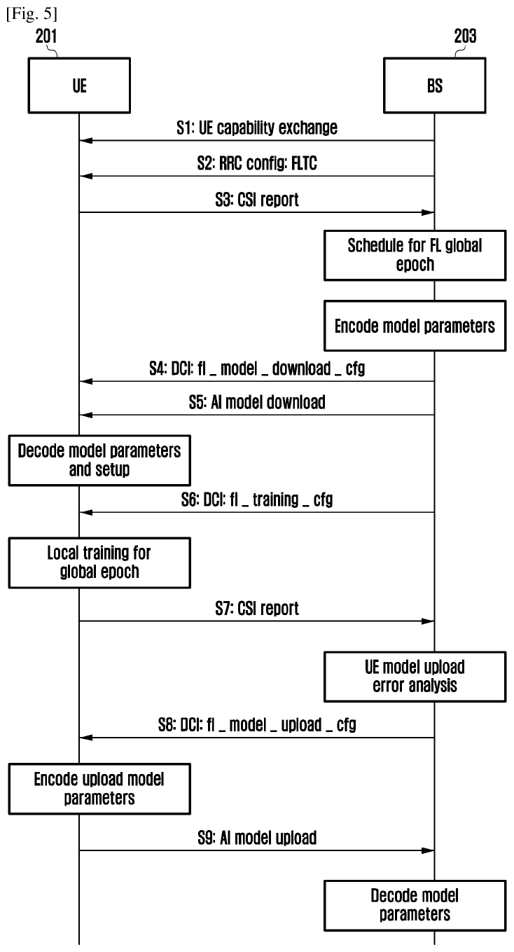

FIG. 5 depicts a sequence diagram that illustrates multi-level FLTC signalling using both RRC message and DCI message, according to the embodiments as disclosed herein.

As shown in FIG. 5, initially consider at step S1, the BS (203) establishes a connection with the UE (201). During the connection establishment, the UE (201) can transmit the capability information to the BS (203). The capability information indicates whether the UE (201) is capable to support the local epoch training. Further, at step S2, the BS (203) transmits a RRC configuration request along with the FLTC based on the capability information of the UE (201). The BS (203) can include all the FLTC parameters in the RRC message if the UE (201) is expected is having a high capability. Further, if the UE (201) is having a low capability, then only some of the FLTC parameters are included in the RRC message.

For example, consider the FLTC can include the parameters such as local_epochs, learning_rate, batch_size, optimizer, method_quantization_type, local_dataset_size, and preprocessing_cfg. Further, the BS (203) can request to share the CSI report from the UE (201). At step S3, the UE (201) transmits CSI report to the BS (203) as requested. Thereafter, the BS (203) determines whether the UE (201) is capable of participating in the local epoch training based on the received CSI report and the capability information. For example, the UE (201) with the best channel conditions and high capability is determined to be capable of participating in the local epoch training. Once the UE (201) is determined to be participating in the local epoch training, the BS (203) encodes the partially trained AI model using an encoding method. Further at step S4, the BS (203) signals a download configuration (fl_model_download_cfg) in DCI message to the UE (201). The download configuration is determined based on the CSI report received from the UE (201). Upon signalling the download configuration, at step S5 the BS (203) transmits the partially trained AI model for local epoch training at the UE (201). Furthermore, the UE (201) decodes the encoded AI model using the received download configuration. Moreover, at step S6, the BS (203) signals a training configuration (fl_training_cfg) in DCI message.

The training configuration (fl_training_cfg) can be used by the UE (201) to locally train the partially trained AI model from the BS (203). Upon receiving the training configuration, the UE (201) trains the partially trained AI model using the local dataset associated with the UE (201). Upon completion of training, at step S7 the UE (201) indicates the BS (203) about the completion of the training and also transmits the CSI report. Furthermore, the BS (203) determines the viability of the locally trained AI model using the latest CSI report received at step S7. Upon the successful validation, at step S8 the BS (203) signals the model upload configuration (fl_model_upload_cfg) to the UE (201) for uploading the locally trained AI model. Upon receiving the model upload configuration, the UE (201) encodes the locally trained AI model using an encoding method as suggested by the BS (203) in the FLTC. Thereafter, at step S9 the UE (201) uploads the encoded locally trained AI model and transmits to the BS (203). Finally, the BS (203) decodes the received encoded locally trained AI model.

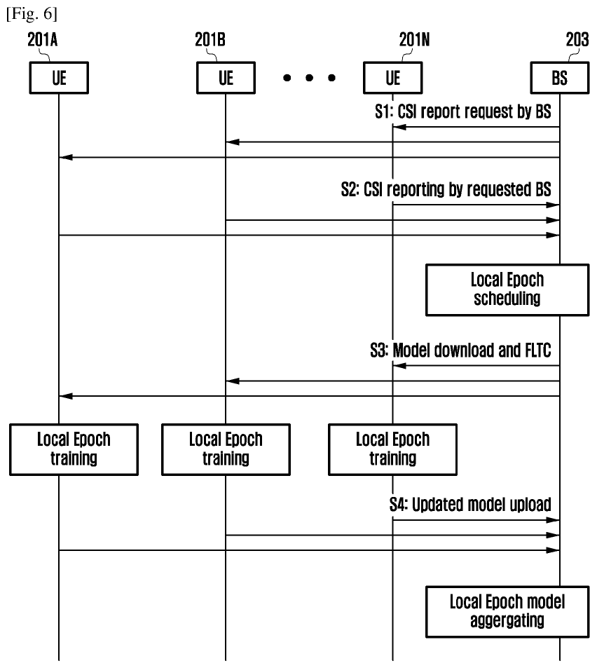

FIG. 6 illustrates signalling flow for a local epoch training by the BS to execute a federated learning in the wireless communication system, according to the embodiments as disclosed herein.

In federated learning to generate the global AI model, the BS (203) selects a plurality of UE (201) for participating in a global epoch and to perform the local epoch training of the partially trained AI model. The process of selecting a set of participant UEs (201) for a global epoch is as shown in FIG. 6. Initially consider at step S1, the BS (203) triggers the plurality of UE (201A, 201B . . . 201N) by transmitting a measurement request for CSI report. Upon receiving the measurement request, the plurality of UEs (201A, 201B . . . 201N) measures the channel conditions of the channels associated with corresponding plurality of UEs (201A, 201B . . . 201N). Further, at step S2 the plurality of UEs (201A, 201B . . . 201N) transmits the CSI report to the BS (203). Upon receiving the CSI report from plurality of UEs (201A, 201B . . . 201N), the BS (203) selects the set of participant UEs (201) based on the received CSI report and schedules the set of participant UEs (201) for performing local epoch training. For example, consider among N UEs, the BS (203) selects M UEs to participate in global epoch, where M≤N. The BS (203) selects the set of participant UEs (201) which is having the best channel conditions. Also, the set of participant UEs (201) that has lesser participation in the federated learning is chosen based on the local dataset properties of the local dataset associated with the set of participant UEs.

After selecting the set of participant UEs (201) at step S3, the BS (203) signals the model download configuration and model training configuration to the UE (201) for the purpose of downloading and training the partially trained AI model transmitted by the BS (203). The set of participant UEs (201) then proceeds to locally train the partially trained AI model using their corresponding local datasets. Upon completion of the training, the set of participant UEs (201) notifies the BS (203) of the completion, after which the BS (203) grants resources for uploading the locally trained AI model. The set of participant UEs (201) then encodes the locally trained AI model and uploads it to the BS (203). The BS (203) receives the encoded locally trained AI model from the set of participant UEs (201).

Before model aggregation, the BS (203) reviews the set of participant UEs (201) from which the locally trained AI models need to be collected and aggregated, based on the CSI report collected from the set of participant UEs upon completion of the local training. The BS (203) disregards the locally trained AI model of the UE in the set of participant UEs (201) that is experiencing a deteriorated CSI. Finally, the BS (203) decodes the encoded locally trained AI model and aggregates the selected locally trained AI model received from set of participant UEs (201). In one embodiment, the BS (203) transmits the encoded locally trained AI model to the parameter server (205) for the aggregation of the locally trained AI model.

The selection of the set of participant UEs based on the CSI report maximizes the participation of the UEs (201) in the global epoch by distributing the partially trained AI model and receiving updates while minimizing the quantization error during the partially trained AI model download and locally trained AI model upload.

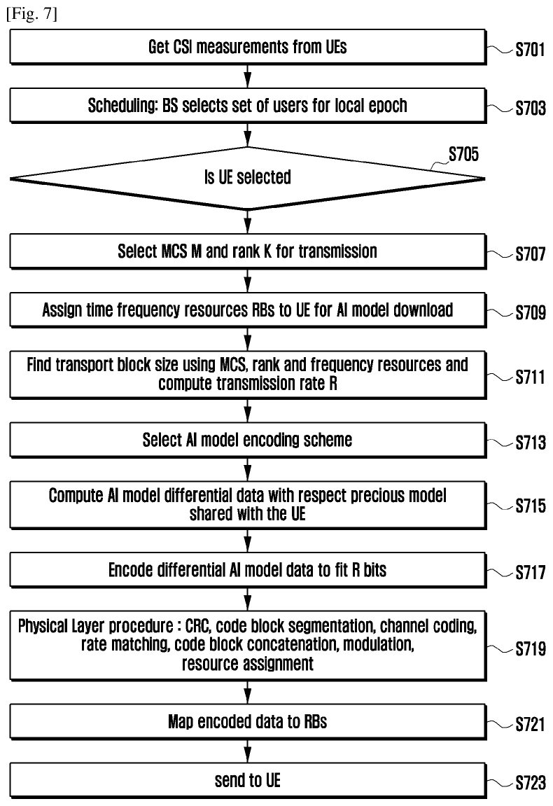

FIG. 7 is a flow diagram illustrating a method for sharing partially trained AI model by the Base Station (BS) with a UE for global epoch participation, according to the embodiments as disclosed herein.

FIG. 7 illustrates a method for sharing the partially trained AI model to the set of participant UEs (201) to perform local epoch training in a global epoch. A global epoch is referred to a single cycle of interaction between the parameter server (205), the base station (203) and the plurality of UEs (201) in the federated learning. The local epoch is referred to as a single cycle of partially trained AI model training at the UE using a local dataset.

In an embodiment, at step S701, the base station (203) receives CSI report from the plurality of UEs (201) in the wireless communication system.

Further, at step S703, the base station (203) selects the set of participant UEs for performing local epoch training in a global epoch based on the received CSI report and the capability information received from the plurality of UEs (201).

In an embodiment, at step S705, the BS (203) determines whether the UE (201) among the plurality of UE (201) is selected for global epoch. If the UE is not selected, then the corresponding UE does not participate in the global epoch of the federated learning.

In an embodiment, at step S707, when the UE (201) is selected as a participant UE for the global epoch, the BS (203) selects the Modulation Coding Scheme (MCS) “M” and rank indicator “K” for the transmission of the partially trained AI model to the UE (201). The rank indicator determines Memory In Memory Output (MIMO) rank information to be used during the partially trained AI model download and locally trained AI model upload. The BS (203) selects the MCS and rank of the set of participant UEs (201) based on the received CSI report.

In an embodiment, at step S709, the base station (203) assigns time frequency resources to the set of participant UE (201) for the partially trained AI model download and locally trained AI model upload.

In an embodiment, at step S711, the BS (203) determines a transport block size based on the MCS, rank, and time frequency resources assigned for the set of participant UEs (201). Also, the BS (203) computes the transmission rate for transmitting the partially trained AI model to the set of participant UEs.

In an embodiment, at step S713, the BS (203) selects the partially trained AI model encoding scheme for partially AI model download and locally trained AI model upload.

In an embodiment, at step S715, the BS (203) computes partially trained AI model differential data with respect to previous model shared with the UE.

In an embodiment, at step S717 the BS (203) encodes the differential partially trained AI model data to fit the transmission rate R bits.

In an embodiment, at step S719 the base station (203) adds a CRC Cyclic Redundancy Check (CRC) to the encoded bit stream. Further a physical layer procedure and resource assignment takes place between the set of participant UE (201) and the base station (203).

In an embodiment, at step S721 the BS (203) maps the encoded data to the assigned time frequency resources Radio bearers.

In an embodiment, at step S723 the BS (203) transmits the encoded partially trained AI model to the set of participant UEs (201) for performing the local epoch training.

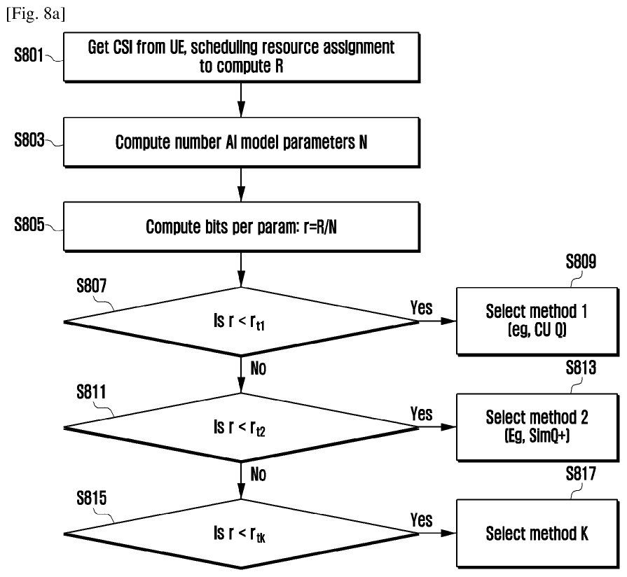

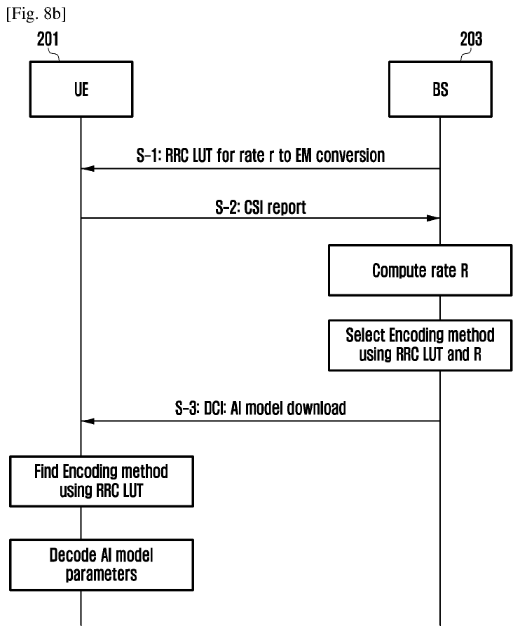

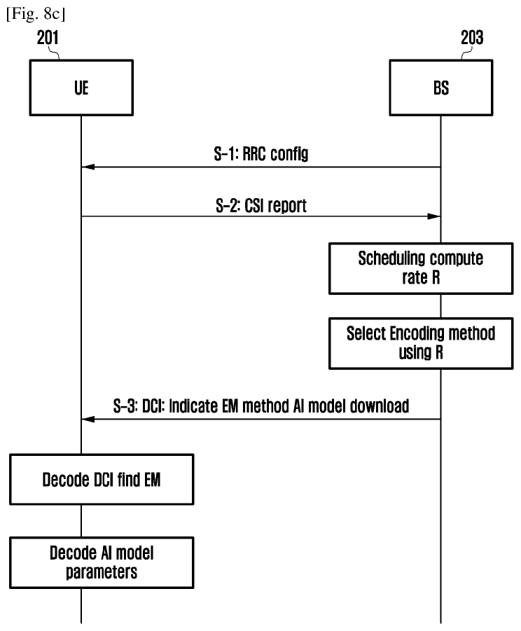

FIG. 8A is a flow diagram illustrating a method for signalling Encoding Method by the BS using RRC message to the UE for federated learning in the wireless communication system, according to the embodiments as disclosed herein. The BS (203) encodes partially trained AI model before transmitting the partially trained AI model to the set of participant UE (201). The encoding is performed using an encoding method. The BS (203) determines the encoding method based on the number of bits assigned per AI model parameter. The selection of the encoding method reduces the bit error rate. Further, the BS (203) coverts partially trained AI model parameters into a bit stream information based on the selected encoding method. FIG. 8A illustrates the steps of selecting an encoding method for encoding the partially trained AI model before transmitting to the set of participant UEs (201). Initially at step S801, the BS (203) receives the CSI report from the plurality of UEs and selects the set of participant UEs based on the received CSI report. Further, the BS (203) selects the MCS, rank and also assigns the time frequency resource Radio bearers (RBs) to the set of participant UEs (201). The BS (203) determines the transmission rate based on the MCS, rank and the time frequency resources RBs. Further at step S803, the BS (203) computes number of partially trained AI model parameters “N”. The AI model parameters can include but not limited to number of layers, number of nodes in each layer activation type, coefficients of scale and bias per node for all the connection in the AI model. Thereafter, the BS (203) determines bits per parameter based on the number of partially trained AI model parameters and the determined transmission rate. Particularly the bits per parameter “r”=R/N.

Furthermore, the BS (203) checks whether the determined bits per parameter (r) exceeds a first pre-defined bit per parameter threshold (rₜ₁). If the bits per parameter is within the first pre-defined bit per parameter threshold as shown in S809, then the BS (203) selects the encoding method 1. For example, the encoding method 1 can include but not limited to a Coordinate-wise Uniform Quantization (CUQ) method. Further if the bits per parameter exceeds the first pre-defined bit per parameter threshold, then the BS (203) continues with step S811.

At step S811, the BS (203) checks whether the bits per parameter is within the second pre-defined bit per parameter threshold as shown in S813, then the BS (203) selects the encoding method 2. For example, the encoding method 2 can include but not limited to a SimQ+ method). Further if the bits per parameter exceeds the second pre-defined bit per parameter threshold, then the BS (203) continues with step S815.

At step S815, the BS (203) checks whether the bits per parameter is within the kth pre-defined bit per parameter threshold as shown in S817, then the BS (203) selects the encoding method k. Further if the bits per parameter exceeds the Kth pre-defined bit per parameter threshold, then the BS (203) continues necessary encoding method based on the determined bits per parameter (r).

Upon selecting the appropriate encoding method, the BS (203) artfully transforms the model parameters into a finely-grained, bit-wise representation. Moreover, the chosen encoding technique is conveyed to the set of participant UE (201) in order to execute both the partially trained AI model download and locally trained AI model upload procedures with precision and efficacy. This transmission is performed via at least one of an RRC message or the DCI message, so as to ensure seamless communication.

FIG. 8B depicts a sequence diagram that illustrates signalling of Encoding Method by the BS using RRC message to the UE for federated learning in the wireless communication system, according to the embodiments as disclosed herein. In an embodiment, as shown in the FIG. 8B the BS (203) can transmit the Encoding Method (EM) through the RRC message. Initially, at step S1, the BS (203) configures a Look-UP Table (LUT) to the participant UE (201). The LUT is maintained to map the bits per AI model parameter (BPMP) to a corresponding encoding method. Further, at step S2 the participant UEs (201) transmits the CSI report to the BS (203). Upon receiving the CSI report, the BS (203) computes the transmission rate “R” based on the selected MCS, rank and time frequency resources Radio bearers. Furthermore, the BS (203) determines an encoding method for the UE (201) using the RRC LUT and the transmission rate “R”. Further, at step S3 the BS (203) encodes the partially trained AI model and transmits the encoded partially trained AI model to the UE (201).

After receiving the encoded partially trained AI model, the UE (201) determines the encoding method based on the RRC LUT received from the BS (203) at step S1. Finally, the UE (201) decodes the received encoded partially trained AI model using the determined encoding method.

FIG. 8C depicts a sequence diagram that illustrates signalling of Encoding Method by the BS using DCI message to the UE for federated learning in the wireless communication system, according to the embodiments as disclosed herein.

In an embodiment, the BS (203) transmits the encoding method explicitly in the DCI message. The steps of sharing the encoding method explicitly in the DCI message is as shown in FIG. 8B. Initially at step S1, the BS (203) establishes a connection and allocates the resources through an RRC message. Further at step S2, the UE (201) transmits the CSI report to the BS (203). Upon receiving the CSI report, the BS (203) selects the set of participant UEs (201) and computes the transmission rate R for each of the set of participant UEs. Further the BS (203) selects an encoding method based on the determined transmission rate “R” Also, the BS (203) encodes the partially trained AI model using the selected encoding method. Furthermore, at step S3, the BS (203) transmits the encoded partially trained AI model to the UE (201) and also explicitly indicates the encoding method in the DCI message. Thereafter, the UE (201) decodes the encoding method indicated in the DCI message. Finally, the BS (203) decodes the encoded partially trained AI model using the indicated encoding method.

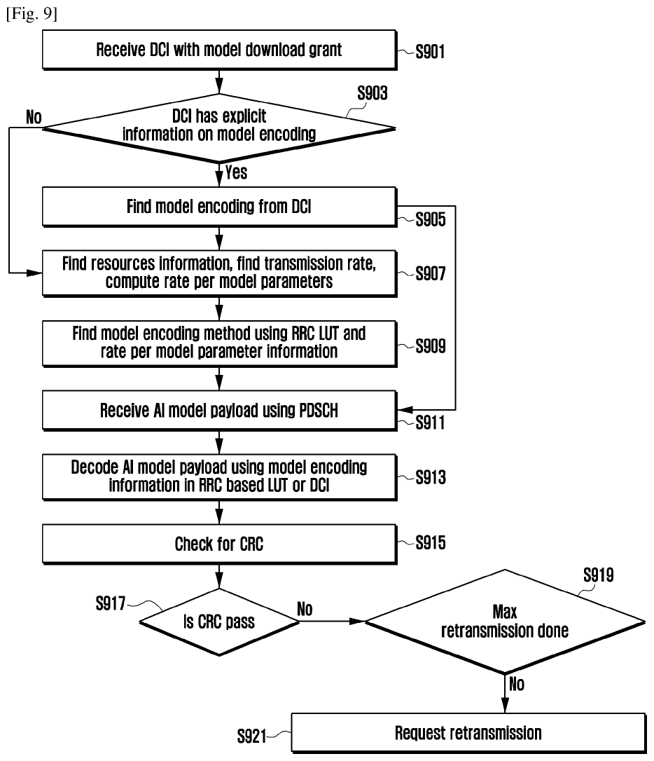

FIG. 9 depicts a flow diagram that illustrates a method of partially trained AI model reception decoding by the UE for federated learning in wireless communication system, according to the embodiments as disclosed herein. The set of participant UEs (201) receives a partially trained AI model from the BS (203). The partially trained AI model is an AI model that is not completely updated and whose performance is low. Thus, the BS (203) transmits the partially trained AI model to set of participant UEs (201) to train the partially trained AI model using the local dataset associated with the set of participant UEs (201). Upon training, the set of UEs (201) transmits the locally trained AI model back to the BS (203). The locally trained AI model, is obtained upon the completion of training the partially trained AI model using the local dataset at the set of participant UEs (201). Further, the partially trained AI model and the locally trained AI model are encoded before the transmission over the wireless communication system. The encoding method used for encoding the partially trained AI model and locally trained AI model is selected based on the determined transmission rate of the BS (203) and the set of participant UEs (201). Initially the BS (203) encodes and transmits the partially trained AI model to the set of participant UEs for performing the local epoch training. The BS (203) transmits the encoding method used for encoding in at least one of the RRC message and DCI message to the set of participant UEs (201). The DCI message explicitly indicates the encoding method used for encoding the partially trained AI model. However, the in the RRC message the encoding method is not explicitly indicated. The RRC message transmits the RRC Look Up Table (LUT) to the set of participant UEs (201). Further, the set of participant UEs (201) determines the Bits Per Model Parameter (BPMP) as a function of total number of AI model parameters and the total number of bits assigned to the UE (201)/transmission rate “R”. Further the UE (201) maps the BPMP with the respective encoding method in the RRC LUT. Thus, the method of decoding the encoded partially trained AI model received from the BS (203) is as shown in FIG. 9. Initially, at step S901 the participant UEs (201) receives a DCI message indicating the grant to download the encoded partially trained AI model. Further, the participant UE (201) determines whether the encoding method is explicitly indicated in the DCI message. Further, at step S905 when the participant UE (201) find the encoding method in the DCI message, the participant UE (201) uses the indicated encoding method for decoding the encoded partially trained AI model. However, at when the encoding method is not explicitly indicated in the DCI message, then at step S907, the participant UE (201) finds the resource information, transmission rate in the RRC message and computes the BPMP based on the total number of model parameters and the transmission rate “R”. Further at step S909, the participant UE (201) finds the encoding method my mapping the determined BPMP to a corresponding encoding method in the RRC LUT. Furthermore at step S911, the participant UE (201) receives AI model payload using Physical Data Shared Channel (PDSCH). Thereafter at step S913 the participant UE (201) decodes the partially trained AI model payload using the determined encoding method. Also, at step S915 the participant UE (201) checks for the Cyclic Redundancy Check (CRC). If the CRC is determined to be successful at S917, then the method is terminated. However, at step S917 when the CRC is determined to be not successful, then at step S919, it is determined whether a maximum retransmission of the locally trained AI model is performed. If the maximum retransmission is not yet completed, then at step S921, the participant UE (201) can request for retransmission of the partially trained AI model. However, at step S919 when the maximum number of retransmissions is already performed, then the process is terminated.

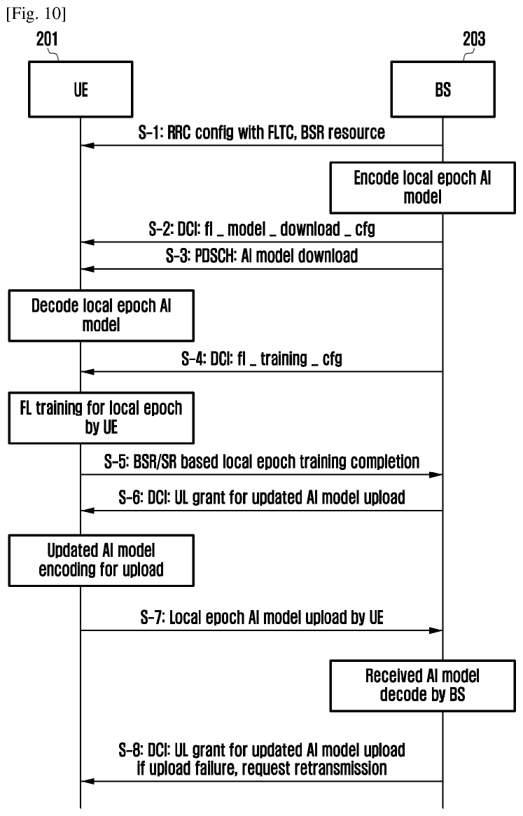

FIG. 10 depicts a sequence diagram that illustrates global training at the UE using a local dataset at the UE, according to the embodiments as disclosed herein. The participant UE (201) decodes the partially trained AI model using the encoding method indicated in at least one of RRC message and the DCI message. Further, the participant UE (201) trains the partially trained AI model using its local dataset. The process of training and sharing the locally trained AI model with the BS (203) is as shown in FIG. 10. Initially at step S1, the BS (203) transmits the RRC message along with FLTC and a request for Buffer Status Report resource to the participant UE (201). Further, the BS (203) encodes the partially trained AI model using a suitable encoding method. Further, at step S2, the BS (203) signals the model download configuration in the DCI message. Also, at step S3 the BS (203) transmits the encoded partially trained AI model to the participant UE (201) in PDSCH. Upon receiving, the participant UE (201) decodes the encoded partially trained AI model for performing local epoch training. Upon decoding, at step S4 the participant UE (201) receives a training configuration (fl_training_cfg) in the DCI message for training the partially trained AI model from the BS (203). Further, the participant UE (201) performs the local training using its local dataset. Thereafter, at step S5 the participant UE (201) indicates the BS (203) regarding the completion of the local training. The time interval by which the participant UE (201) needs to complete the local epoch training is referred to as a local epoch training timer and it is activated upon receiving thefl_training_cfg. Also, at step S5 the participant UE (201) transmits the Buffer Status Report (BSR) to the BS (203). Furthermore, at step S6 the BS (203) provides a grant to upload the locally trained AI model and also assigns the required resources to upload the locally trained AI model in the DCI message. Upon receiving the grant, the participant UE (201) encodes the locally trained AI model using the same encoding method that was indicated initially by the BS (203). Thereafter, at step S7 the participant UE (201) uploads and transmits the encoded locally trained AI model to the BS (203). Finally, the BS (203) receives the encoded locally trained AI model and decodes the locally trained AI model using the determined encoding method. However, if the reception of the locally trained AI model fails then at step S8, the BS (203) can request the participant UE (201) for retransmitting the locally trained AI model. The time interval by which the locally trained AI model should be uploaded back to network is referred to as local epoch model upload timer and it is activated upon receiving the fl_training_cfg.

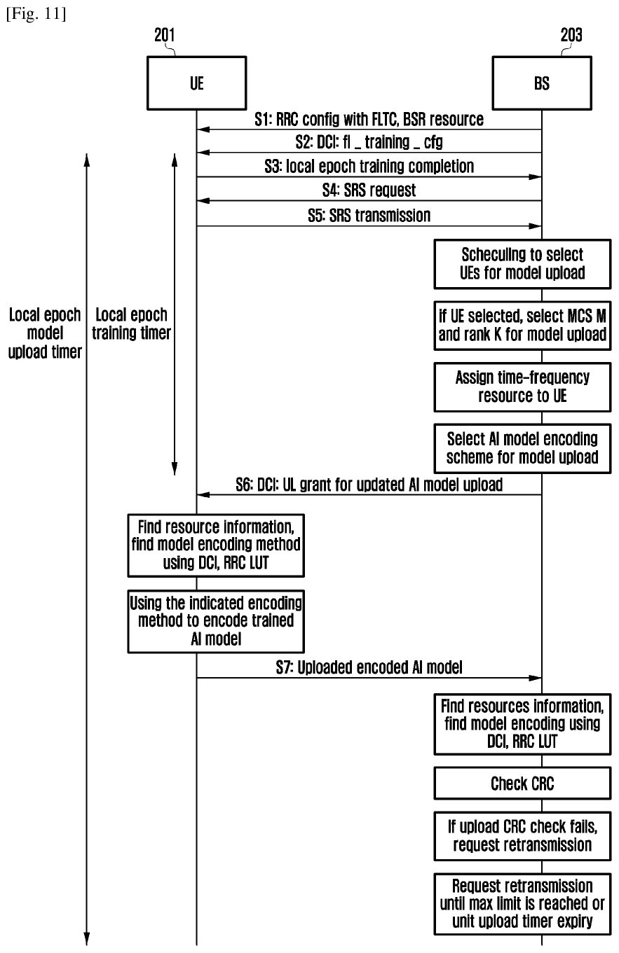

FIG. 11 depicts a sequence diagram that illustrates interaction between the UE and the BS for updating and uploading locally trained AI the model by the UE, according to the embodiments as disclosed herein. The participant UE (201) locally trains the partially trained AI model. Also, the participant UE (201) encodes the locally trained AI model and transmits the encoded locally trained AI model to the BS (203). The participant UE (201) selects the encoding method as shown in the FIG. 11. Initially at step S1, the BS (203) transmits the RRC configuration message along with the FLTC and assigns resources for transmitting the buffer status report for the participant UE (201). Further, at step S2 the BS (203) transmits the training configuration (fl_training_confg) in the DCI message for the participant UE (201) to perform the local training. Thereafter, the participant UE (201) performs the training using the local dataset. Upon the completion of training at step S3 the participant UE (201) transmits the indication of the completion of the local epoch training to the BS (203). Further, at step S4 the BS (203) transmits Sounding Reference Signal (SRS) request to the participant UE (201) for estimating the channel state information. In response to the request, at step S5 the participant UE (201) transmits the SRS response message indicating the channel state information to the BS (203). Upon receiving the channel state information, the BS (203) selects the set of UEs from the set of participant UEs (201) for uploading the locally trained AI model. Upon the selection of the set of UEs of the set of participant UEs (201), the BS (203) selects the MCS “M” and rank “K” for the determined set of UEs (201) to upload the locally trained AI model. Further, the BS (203) assigns time-frequency resources to the determined set of UEs (201). Also, the BS (203) determines an encoding method for encoding the locally trained AI model based on the selected MCS, rank and time-frequency resources. Further, at step S6 the BS (203) transmits the Uplink (UL) grant and assigns the resources for uploading the locally trained AI model to each of the selected set of UEs (201). Upon receiving the UL grant, the participant UE of the set of selected UEs (201) finds the resource information and encoding method for encoding the locally trained AI model. The participant UE of the set of selected UEs (201) determines the encoding method in at least one of the DCI message and the RRC message. Further, the participant UE (201) of the set of participant UEs (201) encoded the locally trained AI model using the determined encoding method. Upon encoding, the participant UE of the set of participant UEs (201) uploads and transmits the encoded locally trained AI model to the BS (203). Furthermore, the BS (203) receives the encoded locally trained AI model using at least one of the DCI messages and RRC message and decodes the encoded locally trained AI model. However, the BS (203) checks whether the status of the CRC is success or failure. When the CRC check is determined to be failed, then the BS (203) requests for the retransmission of the locally trained AI model from the participant UE (201). Also, the retransmission request can be transmitted until a maximum number of retransmissions is reached and until the model upload timer expires.

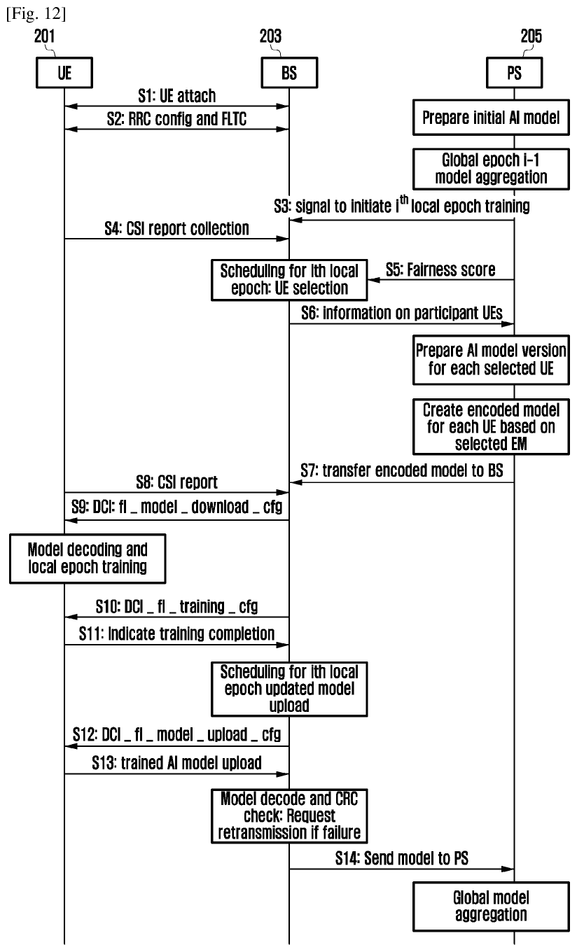

FIG. 12 depicts a sequence diagram that illustrates signalling between the Base station, parameter server and the UE for federated learning in wireless communication system, according to the embodiments as disclosed herein. The interaction between the BS (203) and the plurality of UEs (201) is coordinated with the parameter server (205) to carry out the federated learning training. The federated learning training can be performed in N global epochs. The global epoch indicates a single cycle of generating the global AI model based on the interaction between the plurality of UEs (201), the base station (203) and the parameter server (205). The global AI model is referred to as an updated or aggregated AI model of the plurality of locally trained AI model received from the participant UEs (201). The participant UEs (201) are the UEs participating the local epoch training. The interaction between the parameter server (205), base station (203) and the plurality of UEs (201) is as shown in the FIG. 12. Initially, the parameter server (205) prepares the initial AI model for federated learning. Simultaneously, at step S1 the BS (203) establishes a connection with the plurality of UEs (201). Further, at step S2 the BS (203) establishes the RRC connection with the plurality of UE (201) and transmits the FLTC along with the RRC message. Further, the parameter server (205) can perform model aggregation for the global epoch i−1. Upon the completion of the i−1^{th} global epoch, at step S3 the parameter server (205) initiates the i^{th} global epoch and signals the initiation of the i^{th} global epoch to the BS (203). Further, at step S4 the BS (203) collects the CSI report from plurality of UEs (201). Based on the received CSI report and fairness score received at step S5, the BS (203) selects the participant UEs (201) for participating in the i^{th} global epoch for performing the local epoch training. The fairness score is a score obtained by comparing the participation ratio of the UE (201) in training the partially trained AI model compared to other participant UEs (201). Furthermore, at step S6, the BS (203) transmits the information related to the selected participant UEs (201) participating the global epoch. Upon receiving the participant UEs (201) information, the parameter server prepares a global AI model version for each of the participant UEs (201). Also, the parameter server (205) creates an encoded model for each of the participant UE (201) based on the selected Encoding Method (EM). Further, at step S7 the parameter server (205) transmits the encoded partially trained AI model to the BS (203). Upon receiving the encoded AI model from the parameter server, the BS (203) requests the CSI report from the participant UEs (201). Further, at step S8 the BS (203) receives the CSI report from the participant UEs (201). Thereafter, at step S9 the BS (203) transmits the model download configuration (fl_model_download_cfg) with the participant UEs (201) to download the encoded partially trained AI model. The participant UE (201) decodes the encoded partially trained AI model. Further, at step S10 the BS (203) transmits the training configuration (fl_training_cfg) with the participant UE (201) to locally train the partially trained AI model. Further, the participant UE (201) locally trains the partially trained AI model and indicates the completion of training at step S11. Upon receiving the indication, the BS (203) schedules the resources and provides UL grant to the participant UE (201). Further, at step S12 the BS (203) transmits the model upload configuration (fl_model_upload_cfg) in the DCI message with the participant UE (201). In response to receiving the model upload configuration, at step S13 the participant UE (201) transmits the encoded locally trained AI model to the BS (203). Further, the BS (203) decoded the locally trained AI model and checks the CRC. Thereafter, at step S14 the BS (203) transmits the locally trained AI model received from participant UEs (201) to the parameter server (205). Finally, the parameter server (205) aggregates the locally trained AI model received from the participant UEs (201) to generate a global AI model for the i^{th} global epoch. For example, the aggregation can be performed using a method FedAvg technique.

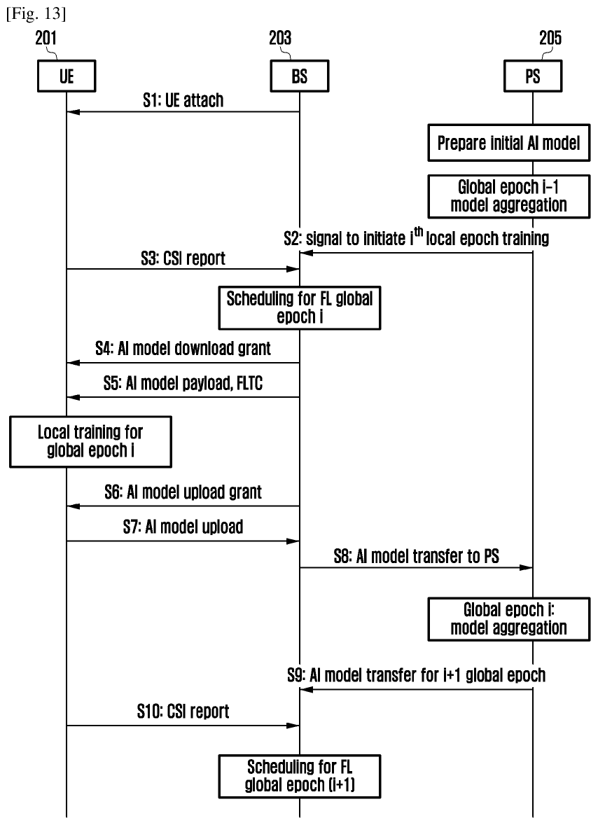

FIG. 13 depicts a sequence diagram that illustrates the federated learning timers to perform federated learning in the wireless communication system, according to the embodiments as disclosed herein. Initially consider the parameter server (205) prepares an initial AI model for the federated learning training. Simultaneously, at step S1 the base station (203) initiates a connection establishment with the plurality of the UEs (201). Further, the parameter server (205) can perform a model aggregation for an i−1th global epoch and further prepares the partially trained AI model for the i^{th} global epoch. Further at step S2 the parameter server (205) transmits the partially trained AI model for the i^{th} global epoch to the BS (203). In response to receiving the partially trained AI model, at step S3 the BS (203) receives the CSI report from the plurality of UEs (201). Furthermore, the BS (203) selects the set of participant UEs for participating in the federated learning of the i^{th} global epoch. Thereafter, at step S4 the BS (203) transmits a model download configuration to the set of participant UEs (201) to download the partially trained AI model. Also, the BS (203) transmits the partially trained AI model payload along with the FLTC to perform the local epoch training. Upon receiving the partially trained AI model, the participant UE (201) performs the local training of the partially trained AI model using the local dataset associated with the participant UE (201). Further, the participant UE (201) indicates the completion of the local epoch training with the BS (203). Upon receiving the completion indication, at step S6 the BS (203) transmits a model upload grant message along with assigning resources requires for uploading the locally trained AI model to the participant UE (201). Further at step S7, the participant UE (201) uploads the locally trained AI model to the BS (203). The participant UE (201) must upload the locally trained AI model within the model upload timer assigned for the participant UE (201). Upon receiving the locally trained AI model, at step S8 the BS (203) transmits the locally trained AI model to the parameter server (205). Finally, the parameter server (205) aggregates the locally trained AI model received from the set of participant UE (201) to generate the global AI model. Further, the performance of the generated global AI model is validated and determines if i+1^{th} global epoch is required for the generated global AI model. However, if the performance of the global AI model generated in the i^{th} global epoch does not meet a predefined performance value, then at step S9 the parameter server (205) transmits the global AI model for federated learning of the i+1th global epoch. Furthermore, at step S10 the BS (203) continues to receive the CSI report for scheduling the plurality of UEs for i+1th global epoch. Thus, the process continues until the global AI model meets a predefined performance criteria.

### Advantages of Present Disclosure

The present disclosure employs federated learning to refine the AI model within a wireless communication system. This approach results in a more sophisticated AI model, which is improved through the use of either local or site-specific datasets at the participating UEs. The beneficial impact of this method is a reduction in uplink overhead, since there is no need to collect local datasets in a centralized location for the purpose of training the AI model.

The AI model is transmitted to a group of participant UEs (201) for training, utilizing the local dataset. Subsequently, each locally trained AI model at the set of participant UEs (201) to produce an updated and global refined AI model. The refined global AI model provides an improved performance due to the utilization of distinct local datasets associated with the set of participant UEs (201).

Furthermore, the preservation of user privacy is upheld as the local dataset is not divulged over the wireless communication system for training purposes. Rather, the AI model is conveyed via the wireless communication system for federated learning to a group of participant UEs (201). Additionally, appropriate encoding methods are utilized to encode the transmission of both the partially trained and locally trained AI models between the BS and the set of UEs. As a result, the encoding of the AI model serves to further diminish the bit error rate during its transmission over the network between the UE and the BS.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within scope of the embodiments as described herein.

1. A method performed by base station (BS) (203) for federated learning in a wireless communication system, the method comprising:
receiving, from a parameter server (PS) (205), a local training request to generate a global AI model through federated learning;
receiving, from a plurality of UEs (201), UE capability information;
receiving, from the plurality of UEs (201), a CSI report;
determining, a set of participant UEs (201) from the plurality of UEs (201) for local epoch training based on the UE capability information and the CSI report received from each of the UEs (201);
determining, a Federated Learning Training Configuration (FLTC) for at least one participant UE (201) of the set of participant UEs (201) based on the CSI received in the CSI report received from each of the participant UEs (201);
transmitting, a partially trained AI model for the local epoch training and the FLTC, wherein the FLTC is different for each participant UE (201) of the set of participant UEs (201) based on which the partially trained AI model needs to be locally trained by the set of participant UEs (201);
receiving, from the set participant UE (201), locally trained AI models,
wherein the locally trained AI models are generated by locally training the partially trained AI model based on the FLTC and the CSI report by the set of participant UEs (201); and
transmitting, to the PS (205), the locally trained AI models received from the set of participant UEs (201) for generating the global AI model.

2. The method as claimed in claim 1, wherein the determining, the set of participant UEs (201) from the plurality of UEs (201) for local epoch training based on the UE capability information and the CSI report received from each of the UEs (201) comprises:
determining, whether channel condition indicated in the CSI report meets a predefined channel condition threshold; and
selecting, the set of participant UEs (201) from the plurality of UEs (201) for local epoch training, wherein the channel condition of the selected set of participant UEs (201) meets the predefined channel condition threshold and the UE capability information of the selected set of participant UEs (201) indicates support for the local epoch training;
wherein the FLTC comprises at least one of layer update information of the at least one layer of the partially trained AI model, a local epoch training timer for the participant UE (201) of the set of participant UEs (201) to locally train the partially trained AI model, a local epoch model upload timer for the participant UE (201) to upload the locally trained AI model, a number of local epochs for the participant UE (201), time resource information for time resources allocated to the participant UE (201) for the local epoch training, frequency resource information for frequency resources allocated to the participant UE (201) for the local epoch training, a learning rate to locally train the partially trained AI model, a batch size for locally training the partially trained AI model, an optimizer to locally train the partially trained AI model, save optimizer state, model quantization type to locally train the partially trained AI model, local dataset size, and preprocessing configuration indicating a type of preprocessing and scaling parameters to locally train the partially trained AI model.

3. The method as claimed in claim 1, wherein the transmitting the FLTC to at least one participant UE (201) of the set of participant UEs (201) comprises:
determining, whether at least one participant UE (201) of the set of participant UEs (201) participates for the local epoch training meets a predefined participation threshold;
transmitting, to the at least one participant UE (201) of the set of participant UEs (201), the FLTC in a RRC message when the at least one participant UE (201) meets the predefined participation threshold; and
transmitting, to the at least one participant UE of the set of participant UEs (201), the FLTC in a DCI message when the at least one participant UE (201) does not meet the predefined participation threshold; wherein the RRC message or the DCI message comprises information about an encoding method used by the BS (203),
wherein receiving, the locally trained AI model from at least one participant UE (201) of the set of participant UEs (201) comprises:
receiving, from at least one participant UE (201) of the set of participant UEs (201), a local epoch training completion message;
transmitting, to at least one participant UE (201) of the set of participant UEs (201), a DCI message to upload the locally trained AI model to the BS (203); and
receiving, by at least one participant UE (201) of the set participant UE (201), the locally trained AI model uploaded;
wherein the method comprises selecting, a BS (203) set of participant UEs (201) from the set of participant UEs (201) that meets a predefined participation threshold.

4. The method as claimed in claim 1, wherein the transmitting, to the set of participant UEs (201), the partially trained AI model for the local epoch training comprises:
receiving, from the PS (205), the partially trained AI model;
determining, MCS and RI based on the CSI report received from at least one participant UE (201) of the set of participant UEs (201);
assigning, time and frequency resources to at least one participant UE (201) of the set of participant UEs (201);
determining, a payload based on the MCS, RI, and the assigned time and frequency resources to at least one participant UE (201) of the set of participant UEs (201);
determining, differential data for the partially trained AI model based on a previously shared AI model with at least one participant UE (201) of the set of participant UEs (201);
encoding, the differential data for the partially trained AI model; and
transmitting, to at least one participant UE (201) of the set of participant UEs (201), the encoded partially trained AI model with the differential data;
wherein receiving, from the PS (205), the partially trained AI model, comprises:
receiving, from the PS (205), a request to share a fairness score of the at least one participant UE (201) of the set of participant UEs (201);
sending, to the PS (205), the fairness score and information about the at least one participant UE (201); and
receiving, the partially trained AI model generated by the PS (205) based on the fairness score and information about the at least one participant UE (201);
wherein encoding, the differential data for the partially trained AI model comprises:
determining, an encoding method supported by the UE (201) and the BS (203) from a plurality of encoding methods based on at least one of bits per AI model parameter (BPMP) with RRC LUT and DCI based explicit signalling; and
encoding, the differential data for the partially trained AI model using the encoding method supported by the UE (201) and the BS (203).

5. A method performed by user equipment (201) for federated learning in wireless communication system, the method comprising:
transmitting, to a BS (203), UE capability information, wherein the UE capability information indicates support for a local epoch training;
transmitting, to the BS (203), a CSI report;
receiving, from the BS (203), a partially trained AI model for the local epoch training and a Federated Learning Training Configuration (FLTC) specific to the UE (201) for the local epoch training;
decoding, the partially trained AI model;
generating, a locally trained AI model by locally training the partially trained AI model based on the FLTC and the CSI report; and
transmitting, to the BS (203), the locally trained AI model.

6. The method as claimed in claim 5,
wherein the receiving the FLTC specific to the UE comprises receiving the FLTC specific to the UE in one of a RRC message and a DCI message when the at least one participant UE (201) does not meet a predefined participation threshold, wherein the RRC message or the DCI message comprises information about an encoding method used by the BS (203),
wherein decoding, the partially trained AI model comprises:
determining, whether information about an encoding method used by the BS (203) is received by the UE (201) in the RRC message or the DCI message;
performing, one of:
decoding, the partially trained AI model using the encoding method used by the BS (203) when information about an encoding method used by the BS (203) is received by the UE (201), wherein the encoding method is supported by the UE (201) and the BS (203); and
determining an encoding method from a plurality of encoding methods based on at least one of bits per AI model parameter (BPMP) with RRC LUT and DCI based explicit signalling, and decoding, the partially trained AI model using the encoding method,
wherein the transmitting, to the BS (203), the locally trained AI model comprises:
sending, to the BS (203), a local epoch training completion message after completion of the locally training of the partially trained AI model;
receiving, from the BS (203), a DCI message to upload the locally trained AI model to the BS (203); and
uploading, to the BS (203), the locally trained AI model.

7. A method performed by a parameter server (PS (205)) (205) for federated learning in a wireless communication system, the method comprising:
sending, to a BS (203), a local training request;
receiving, information about at least one participant UE (201) for a local epoch training and a fairness score associated with the at least one participant UE (201);
generating, a partially trained AI model for the at least one participant UE (201) based on the information about the at least one participant UE (201) for the local epoch training and the fairness score;
transmitting, to the BS (203), the partially trained AI model for local epoch training by the at least one participant UE (201);
receiving, from the BS (203), locally trained AI models, wherein the locally trained AI model is generated by locally training the partially trained AI model by the at least one participant UE (201); and
generating, a global AI model by aggregating the locally trained AI models received form the BS (203).

8. A Base Station (BS (203)) (203) for federated learning in a wireless communication system, the BS (203) comprising:
a memory;
a processor; and
a federated learning controller, communicatively coupled to the memory and the processor, configured to:
receive, a local training request to generate a global AI model through federated learning from a parameter server (PS (205)) (205);
receive UE capability information from a plurality of UEs (201);
receive a CSI report from the plurality of UEs (201);
determine a set of participant UEs (201) from the plurality of UEs (201) for local epoch training based on the UE capability information and the CSI report received from each of the UEs (201);
determine a Federated Learning Training Configuration (FLTC) for at least one participant UE (201) of the set of participant UEs (201) based on the CSI received in the CSI report received from each of the participant UEs (201);
transmit a partially trained AI model for the local epoch training and the FLTC to the set of participant UEs (201), wherein the FLTC is different for each participant UE (201) of the set of participant UEs (201) based on which the partially trained AI model needs to be locally trained by the set of participant UEs (201);
receive locally trained AI models from the set participant UE (201),
wherein the locally trained AI models are generated by locally training the partially trained AI model based on the FLTC and the CSI report by the set of participant UEs (201); and
transmit the locally trained AI models received from the set of participant UEs (201) to the PS (205) for generating the global AI model.

9. The BS (203) as claimed in claim 8, wherein determine the set of participant UEs (201) from the plurality of UEs (201) for local epoch training based on the UE capability information and the CSI report received from each of the UEs (201) comprises:
determine whether channel condition indicated in the CSI report meets a predefined channel condition threshold; and
select the set of participant UEs (201) from the plurality of UEs (201) for local epoch training, wherein the channel condition of the selected set of participant UEs (201) meets the predefined channel condition threshold and the UE capability information of the selected set of participant UEs (201) indicates support for the local epoch training;
wherein the FLTC comprises at least one of layer update information of at least one layer of the partially trained AI model, a local epoch training timer for the participant UE (201) of the set of participant UEs (201) to locally train the partially trained AI model, a local epoch model upload timer for the participant UE (201) to upload the locally trained AI model, a number of local epochs for the participant UE (201), time resource information for time resources allocated to the participant UE (201) for the local epoch training, frequency resource information for frequency resources allocated to the participant UE (201) for the local epoch training, a learning rate to locally train the partially trained AI model, a batch size for locally training the partially trained AI model, an optimizer to locally train the partially trained AI model, save optimizer state, model quantization type to locally train the partially trained AI model, local dataset size, and preprocessing configuration indicating a type of preprocessing and scaling parameters to locally train the partially trained AI model.

10. The BS (203) as claimed in claim 8, wherein transmit the FLTC to at least one participant UE (201) of the set of participant UEs (201) comprises:
determine whether at least one participant UE (201) of the set of participant UEs (201) participates for the local epoch training meets a predefined participation threshold;
transmit the FLTC to the at least one participant UE (201) of the set of participant UEs (201) in a RRC message when the at least one participant UE meets the predefined participation threshold; and
transmit the FLTC to the at least one participant UE (201) of the set of participant UEs (201) in a DCI message when the at least one participant UE (201) does not meet the predefined participation threshold;
wherein the RRC message or the DCI message comprises information about an encoding method used by the BS (203),
wherein to select at least one participant UEs (201) from the set of participant UEs (201) that meets a predefined participation threshold,
wherein receive the locally trained AI model from at least one participant UE (201) of the set of participant UEs (201) comprises:
receive a local epoch training completion message from at least one participant UE (201) of the set of participant UEs (201);
transmit a DCI message to at least one participant UE (201) of the set of participant UEs (201) to upload the locally trained AI model to the BS (203); and
receive the locally trained AI model uploaded by at least one participant UE (201) of the set participant UE (201).

11. The BS (203) as claimed in claim 8, wherein transmit the partially trained AI model for the local epoch training comprises:
receive the partially trained AI model from the PS (205);
determine MCS and RI based on the CSI report received from at least one participant UE (201) of the set of participant UEs (201);
assign time and frequency resources to at least one participant UE (201) of the set of participant UEs (201);
determine a payload based on the MCS, RI, and the assigned time and frequency resources to at least one participant UE (201) of the set of participant UEs (201);
determine differential data for the partially trained AI model based on a previously shared AI model with at least one participant UE (201) of the set of participant UEs (201);
encode the differential data for the partially trained AI model; and
transmit the encoded partially trained AI model with the differential data to at least one participant UE (201) of the set of participant UEs (201);
wherein receive the partially trained AI model from the PS (205) comprises:
receive a request to share a fairness score of the at least one participant UE (201) of the set of participant UEs (201) from the PS (205);
send the fairness score and information about the at least one participant UE (201) to the PS (205); and
receive the partially trained AI model generated by the PS (205) based on the fairness score and information about the at least one participant UE (201);
wherein encode the differential data for the partially trained AI model comprises:
determine an encoding method supported by the UE (201) and the BS (203) from a plurality of encoding methods based on at least one of bits per AI model parameter (BPMP) with RRC LUT and DCI based explicit signalling; and
encode the differential data for the partially trained AI model using the encoding method supported by the UE (201) and the BS (203).

12. The user equipment (UE) (201) for federated learning in a wireless communication system, the UE (201) comprising:
a memory;
a processor; and
a federated learning controller, communicatively coupled to the memory and the processor, configured to:
transmit UE capability information to a BS (203) in the wireless communication system, wherein the UE capability information indicates support for the local epoch training;
transmit a CSI report to the BS (203);
receive a partially trained AI model for the local epoch training and a FLTC specific to the UE (201) from the BS (203) for the local epoch training;
decode by the UE (201), the partially trained AI model;
generate a locally trained AI model by locally training the partially trained AI model based on the FLTC and the CSI report; and
transmit the locally trained AI model to the BS (203).

13. The UE (201) as claimed in claim 12, wherein the federated learning controller is configured to:
receive the FLTC specific to the UE (201) from the BS (203) in one of a RRC message and a DCI message when the at least one participant UE (201) does not meet the predefined participation threshold, wherein the RRC message or the DCI message comprises information about an encoding method used by the BS (203);
wherein decode the partially trained AI model comprises:
determine whether information about an encoding method used by the BS (203) is received by the UE (201);
perform one of:
decode the partially trained AI model using the encoding method used by the BS (203) when information about an encoding method used by the BS (203) is received by the UE (201), wherein the encoding method is supported by the UE (201) and the BS (203), and
determine an encoding method from a plurality of encoding methods based on at least one of bits per AI model parameter (BPMP) with RRC LUT and DCI based explicit signalling, and decoding, by the UE (201), the partially trained AI model using the encoding method.

14. The UE (201) as claimed in claim 12, wherein transmit the locally trained AI model to the BS (203) comprises:
send a local epoch training completion message to the BS (203) after completion of the locally training of the partially trained AI model;
receive a DCI message from the BS (203) to upload the locally trained AI model to the BS (203); and
upload the locally trained AI model to the BS (203).

15. A parameter server (PS (205)) (205) for federated learning in a wireless communication system, the PS (205) comprising:
a memory;
a processor; and
a federated learning controller, communicatively coupled to the memory and the processor, configured to:
send a local training request to a BS (203);
receive information about at least one participant UE (201) for a local epoch training and a fairness score associated with the at least one participant UE (201);
generate a partially trained AI model for the at least one participant UE (201) based on the information about the at least one participant UE (201) for the local epoch training and the fairness score;
transmit the partially trained AI model to the BS (203) for local epoch training by the at least one participant UE (201);
receive locally trained AI models from the BS (203), wherein the locally trained AI model is generated by locally training the partially trained AI model by the at least one participant UE (201); and
generate a global AI model by aggregating the locally trained AI models received from the BS (203).
